(19) United States
(12) Patent Application Publication
(10) Pub. No.: US 2014/0082573 A1
(43) Pub. Date: Mar. 20, 2014

(54) CIRCUIT DESIGN SUPPORT APPARATUS, CIRCUIT DESIGN SUPPORT METHOD, AND COMPUTER PRODUCT

(71) Applicant: FUJITSU LIMITED, Kawasaki-shi (JP)

(72) Inventor: Shiho NAKAHARA, Nerima (JP)

(73) Assignee: FUJITSU LIMITED, Kawasaki-shi (JP)

(21) Appl. No.: 13/953,309

(22) Filed: Jul. 29, 2013

(30) Foreign Application Priority Data
Sep. 19, 2012 (JP) 2012-206378

(51) Int. Cl. G06F 17/50

(52) U.S. Cl. CPC G06F 17/5059
USPC 716/108

(57) ABSTRACT

A circuit design support apparatus includes a processor configured to calculate a time period necessary for a transition of a logical state, based on circuit configuration information indicating connection relations of elements of an integrated circuit and input information indicating a logical value input into an input terminal of the integrated circuit; calculate capacitance between power source wires in each logical state based on the circuit configuration information and the input information; and calculate temporal variation of the capacitance based on the capacitance and the time period.

### CROSS REFERENCE TO RELATED APPLICATIONS

This application is based upon and claims the benefit of priority of the prior Japanese Patent Application No. 2012-206378, filed on Sep. 19, 2012, the entire contents of which are incorporated herein by reference.

### FIELD

The embodiments discussed herein are related to a circuit design support apparatus, a circuit design support method, and a computer product, for an integrated circuit.

### BACKGROUND

In a digital circuit, an excessively large amount of current flows causing noise when the logic thereof transitions. According to one method, junction capacitance, which is parasitic capacitance between a semiconductor substrate and a well in the semiconductor substrate, is modeled using a multi-terminal F-matrix; a simulation is executed for the effects of noise entering the substrate through junction capacitance; whereby, substrate noise of an integrated circuit is analyzed (see, e.g., Japanese Laid-Open Patent Publication No. 2003-162559).

According to another method, each cell in a library preliminarily stores the waveform of current flowing from a power source; the waveform of the current flowing from the power source is produced according to a value input into each cell in a digital circuit; the produced waveforms are totaled; whereby, the waveform of the current flowing from the power source by the digital circuit is produced (see, e.g., Japanese Laid-Open Patent Publication No. 2006-285960).

According to a further method, from information concerning the design of an integrated circuit, an operating portion of the integrated circuit described in the information is automatically produced such that current flowing in a power source terminal of the integrated circuit can be caused to flow equivalently. A model of the operating portion of the integrated circuit is described using a current source, or a transistor that causes equivalent flows of current (see, e.g., Japanese Laid-Open Patent Publication No. 2009-199338).

Nonetheless, according to the conventional methods, no consideration is made for current that flows from the power source when an inter-power-source capacitance between a power source wire and a ground wire varies consequent to the transition of the input value. Therefore, at the design stage of the integrated circuit, the current flowing from the power source during the operation of the integrated circuit can not be estimated with high accuracy. For example, the inventor compared estimated values acquired by analysis and actual measurement values for the frequency property of current flowing from a power source, that is, a current spectrum thereof. The estimated values substantially coincided with the actual measurement values for even-numbered harmonics of the clock frequency. However, the estimated values were smaller than the actual measurement values for odd-numbered harmonics of the clock frequency. When the analytic accuracy of the current flowing from the power source is low as above, a problem arises in that no electromagnetic interference (EMI) can be estimated with high accuracy.

### SUMMARY

According to an aspect of an embodiment, a circuit design support apparatus includes a processor configured to calculate a time period necessary for a transition of a logical state, based on circuit configuration information indicating connection relations of elements of an integrated circuit and input information indicating a logical value input into an input terminal of the integrated circuit; calculate capacitance between power source wires in each logical state based on the circuit configuration information and the input information; and calculate temporal variation of the capacitance based on the capacitance and the time period.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of inter-power-source capacitance of a standard cell in a first state;

FIG. 2 is an explanatory diagram of inter-power-source capacitance of the standard cell in a second state;

FIG. 3 is an explanatory diagram of inter-wire capacitance in a third state;

FIG. 4 is an explanatory diagram of inter-wire capacitance in a fourth state;

FIG. 5 is a diagram of an example of an integrated circuit;

FIG. 6 is a diagram of an example of a linear circuit model of an integrated circuit power source;

FIG. 7 is a diagram of an example of temporal variation of inter-power-source capacitance of the integrated circuit;

FIG. 8 is a diagram of an example of a current-temporal waveform for the temporal variation of the inter-power-source capacitance depicted in FIG. 7;

FIG. 9 is a block diagram of a hardware configuration of a circuit design support apparatus according to an embodiment;

FIG. 10 is a diagram of an example of a functional configuration of a circuit design support apparatus according to the embodiment;

FIG. 11 is a diagram of an example of a circuit design support method according to the embodiment;

FIG. 12 is a diagram of another example of the functional configuration of the circuit design support apparatus according to the embodiment;

FIG. 13 is a diagram of another example of the circuit design support method according to the embodiment;

FIG. 14 is a diagram of another example of the temporal variation of the capacitance between the power sources of the integrated circuit;

FIG. 15 is a diagram of another example of the current-temporal waveform for the temporal variation of the capacitance between the power sources depicted in FIG. 14;

FIG. 16 is a diagram (Part I) of another example of a linear circuit model of the integrated circuit power source; and

FIG. 17 is a diagram (Part II) of another example of the linear circuit model of the integrated circuit power source.

### DESCRIPTION OF EMBODIMENTS

Preferred embodiments of a circuit design support apparatus, a circuit design support method, and a program will be described in detail with reference to the accompanying drawings. In the description of each of the examples hereinafter, identical elements are given the same reference numerals and redundant description is omitted.

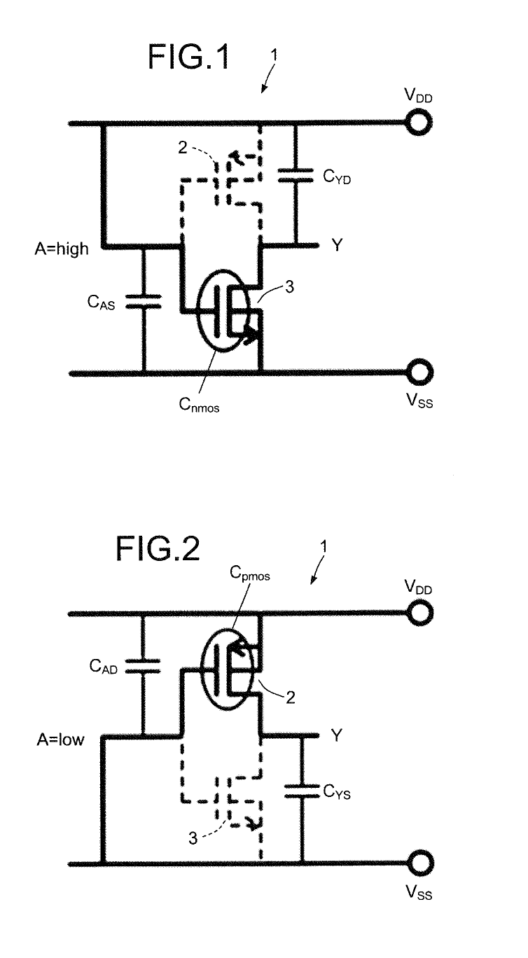

FIG. 1 is an explanatory diagram of inter-power-source capacitance of a standard cell in a first state. FIG. 2 is an explanatory diagram of inter-power-source capacitance of the standard cell in a second state. The standard cell is a logic element that constitutes an integrated circuit such as, for example, an inverter, a buffer, a NAND, a NOR, an AND, an OR, an XOR, or each of various flip-flops, or a combined cell formed by combining some of these elements, and is provided by a standard cell library. In the embodiment, inter-power-source capacitance of the standard cell will be described taking an example of an inverter cell.

As depicted in FIG. 1, for the inverter cell 1, when a logical value input into an input terminal “A” is “high”, a PMOS transistor 2 is turned off and an NMOS transistor 3 is turned on. Thereby, “Cₙₘₒₛ”, “C_{AS}”, and “C_{YD}” form the inter-power-source capacitance “C_{cell}” of the inverter cell.

“Cₙₘₒₛ” is parasitic capacitance related to the NMOS transistor 3 and is constituted mainly of junction capacitance between a substrate and a well, and gate capacity. “C_{AS}” is parasitic capacitance between a signal wire connected to the input terminal A and a power supply wire V_{SS}. “C_{YD}” is parasitic capacitance between a signal wire connected to an output terminal Y and a power supply wire V_{DD}.

Therefore, as expressed by Eq. (1), when the logical value of an input is “high”, the inter-power-source capacitance C_{cell} of the inverter cell is capacitance formed by a combination of Cₙₘₒₛ, C_{AS}, and C_{YD}.

C_{cell}=C_{AS}+C_{YD}+Cₙₘₒₛ (1)

On the other hand, as depicted in FIG. 2, for the inverter cell 1, when the logical value input into the input terminal “A” is “low”, the NMOS transistor 3 is turned off and the PMOS transistor 2 is turned on. Thereby, “Cₚₘₒₛ”, “C_{AD}”, and “C_{YS}” form the inter-power-source capacitance “C_{cell}” of the inverter cell.

“Cₚₘₒₛ,” is parasitic capacitance related to the PMOS transistor 2 and is constituted mainly of junction capacitance between the substrate and the well, and a gate capacity. “C_{AD}” is parasitic capacitance between a signal wire connected to the input terminal A and the power supply wire V_{DD}. “C_{YS}” is parasitic capacitance between a signal wire connected to the output terminal Y and the power supply wire V_{SS}.

Therefore, as expressed by Eq. (2), when the logical value of the input is “low”, the inter-power-source capacitance C_{cell} of the inverter cell is capacitance formed by a combination of Cₚₘₒₛ, C_{AD}, and C_{YS}.

C_{cell}=C_{AD}+C_{YS}+Cₚₘₒₛ (2)

As is clear from Eqs. (1) and (2), the inter-power-source capacitance C_{cell} of the inverter cell is dependent on the state of the inverter cell. The same is true for a standard cell other than an inverter cell such as a NAND cell, and a cell formed by combining standard cells. The inter-power-source capacitance C_{cell} of such a cell is also dependent on the state of the cell. The parasitic capacitance of the standard cell in each state can be acquired by executing a simulation of varying according to the logical value, the voltage input into the input terminal of the standard cell, using an existing circuit analysis engine such as, for example, “SPICE”.

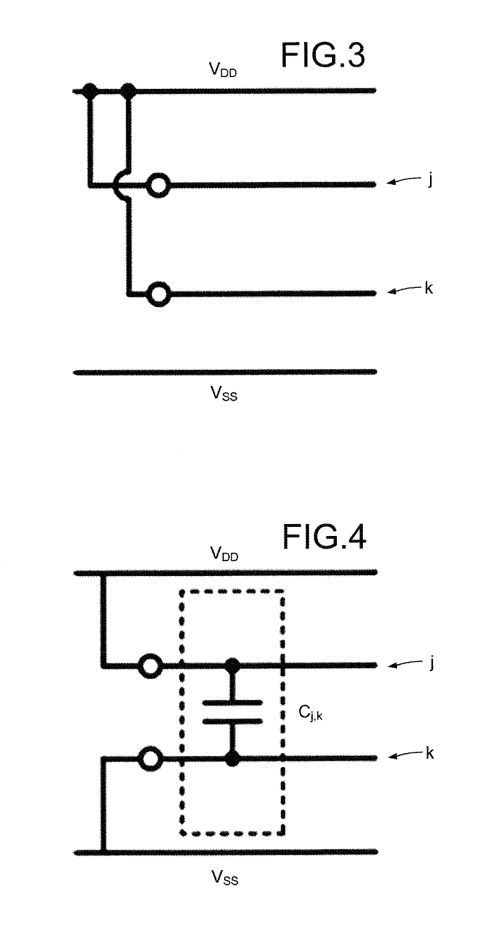

FIG. 3 is an explanatory diagram of inter-wire capacitance in a third state. FIG. 4 is an explanatory diagram of inter-wire capacitance in a fourth state. The inter-wire capacitance is parasitic capacitance between signal or power supply wires that connect cells to each other.

As depicted in FIG. 3, as in a case where signal wires “j” and “k” are connected to, for example, the power supply wire V_{DD} through, for example, a transistor upstream, and the electric potentials of the signal wires j and k are equal to each other, an inter-wire capacitance C_{wire} between the signal wires j and k is zero. The same is true for a case where the signal wires j and k are connected to, for example, the power supply wire V_{SS}.

As depicted in FIG. 4, as in a case where the signal wire j is connected to, for example, the power supply wire V_{DD} and the signal wire k is connected to, for example, the power supply wire V_{SS}, the electric potentials of the signal wires j and k may be different from each other. In this case, the inter-wire capacitance C_{wire} between the signal wires j and k is C_{j, k}.

State Dependence of Inter-Power-Source Capacitance C_{LSI} of Integrated Circuit

The inter-power-source capacitance C_{LSI} of an integrated circuit is a combined capacitance of the inter-power-source capacitance C_{cell} and the inter-wire capacitance C_{wire} of the standard cell as expressed by Eq. (3).

C_{LSI}=C_{cells}+C_{wire} (3)

The state dependence of the inter-power-source capacitance C_{cell} of the standard cell and the inter-wire capacitance C_{wire}, and the inter-power-source capacitance C_{LSI} of an integrated circuit is disclosed by Hagiwara, Shiho, et al in “Linear time calculation of on-chip power distribution network capacitance considering state-dependence” (IEICE Transactions on Fundamentals of Electronics, Vol. E93-A, No. 12, pp. 2409-2416, December 2010) and further by Hagiwara, Shiho, et al in “Linear Time Calculation of State-Dependent Power Distribution Network Capacitance” (International Symposium on Quality Electronic Design (ISQED), pp. 75-80, San Jose, March 2010.)

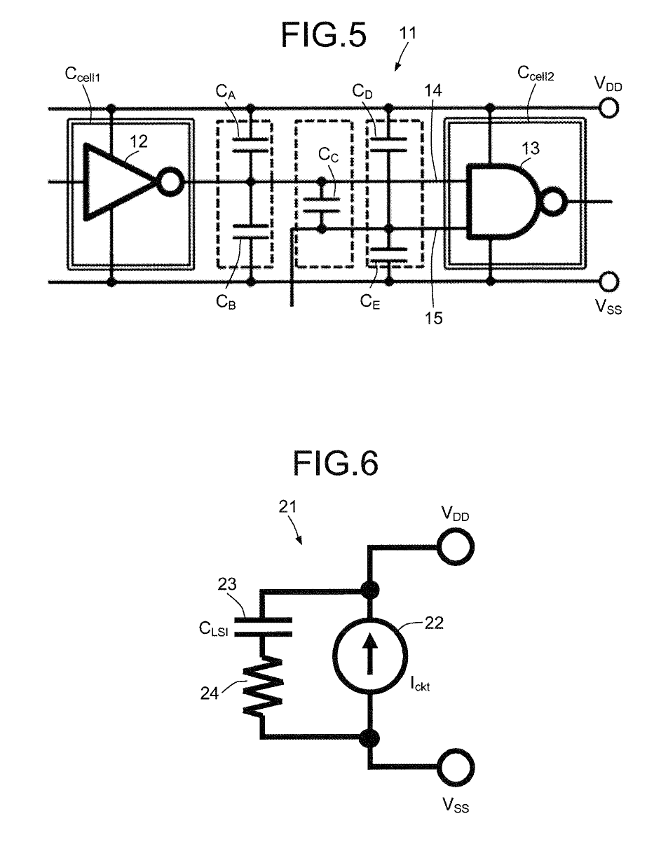

FIG. 5 is a diagram of an example of the integrated circuit. An integrated circuit 11 depicted in FIG. 5 includes an inverter cell 12 encompassed by a double line and a NAND cell 13 also encompassed by a double line. The inverter cell 12 and the NAND cell 13 are connected to the power supply lines V_{DD} and V_{SS}. An output terminal of the inverter cell 12 and a first input terminal of the NAND cell 13 are connected to each other by a signal wire 14. A second input terminal of the NAND cell 13 is connected to another signal wire 15.

Inter-power-source capacitance of the inverter cell 12 is denoted by “C_{cell1}”. Inter-power-source capacitance of the NAND cell 13 is denoted by “C_{cell2}”. Inter-wire capacitance between the power supply wire V_{DD} and the signal wire 14 is denoted by “C_{A}”. Inter-wire capacitance between the signal wire 14 and the power supply wire V_{SS} is denoted by “C_{B}”. Inter-wire capacitance between the signal wires 14 and 15 is denoted by “C_{C}”. Inter-wire capacitance between the power supply wire V_{DD} and the signal wire 15 is denoted by “C_{D}”. Inter-wire capacitance between the signal wire 15 and the power supply wire V_{SS} is denoted by “C_{E}”.

When the logical value of an input to the inverter cell 12 and the logical value of an input to the second input terminal of the NAND cell 13 are both “high”, C_{A}, C_{C}, and C_{E} are selected as parasitic capacitance. Therefore, the inter-power-source capacitance C_{LSI} of the integrated circuit is a combined capacitance of C_{cell1}, C_{cell2}, C_{A}, C_{C}, and C_{E}.

When the logical value of the input to the inverter cell 12 is “high” and the logical value of the input to the second input terminal of the NAND cell 13 is “low”, C_{A} and C_{D} are selected as parasitic capacitance. Therefore, the inter-power-source capacitance C_{LSI} of the integrated circuit is a combined capacitance of C_{cell1}, C_{cell2} C_{A}, and C_{D}.

When the logical value of the input to the inverter cell 12 is “low” and the logical value of the input to the second input terminal of the NAND cell 13 is “high”, C_{B} and C_{E} are selected as parasitic capacitance. Therefore, the inter-power-source capacitance C_{LSI} of the integrated circuit is a combined capacitance of C_{cell1}, C_{cell2}, C_{B}, and C_{E}.

When the logical value of the input to the inverter cell 12 and the logical value of the input to the second input terminal of the NAND cell 13 are both “low”, C_{B}, C_{C}, and C_{D} are selected as parasitic capacitance. Therefore, the inter-power-source capacitance C_{LSI} of the integrated circuit is a combined capacitance of C_{cell1}, C_{cell2}, C_{B}, C_{C}, and C_{D}.

FIG. 6 is a diagram of an example of a linear circuit model of an integrated circuit power source. For example, an integrated circuit 11 as depicted in FIG. 5 can be represented as a linear circuit model 21 of the integrated circuit power source as depicted in FIG. 6. In the linear circuit model 21 of the integrated circuit power source, a current source 22 is connected between the power supply wires V_{DD} and V_{SS}, and a capacitive element 23 and a resistive element 24 are connected in series between the power supply wires V_{DD} and V_{SS}.

In FIG. 6, “I_{ckt}” denotes current that is caused to flow between the power supply wires V_{DD} and V_{SS} by the inverter cell 12 and the NAND cell 13. “C_{LSI}” denotes a capacitance value of the capacitive element 23 and, for the integrated circuit 11 depicted in FIG. 5, is, for example, the inter-power-source capacitance C_{LSI} of the integrated circuit 11 in the above four states. The resistive element 24 is the interconnection resistance of the signal wires 14 and 15. In the model depicted in FIG. 6, C_{LSI} varies according to each of the four states and current flows that corresponds to I_{ckt} and C_{LSI}.

Current I_{cap}(t) Flowing in Response to Variation of Inter-Power-Source Capacitance

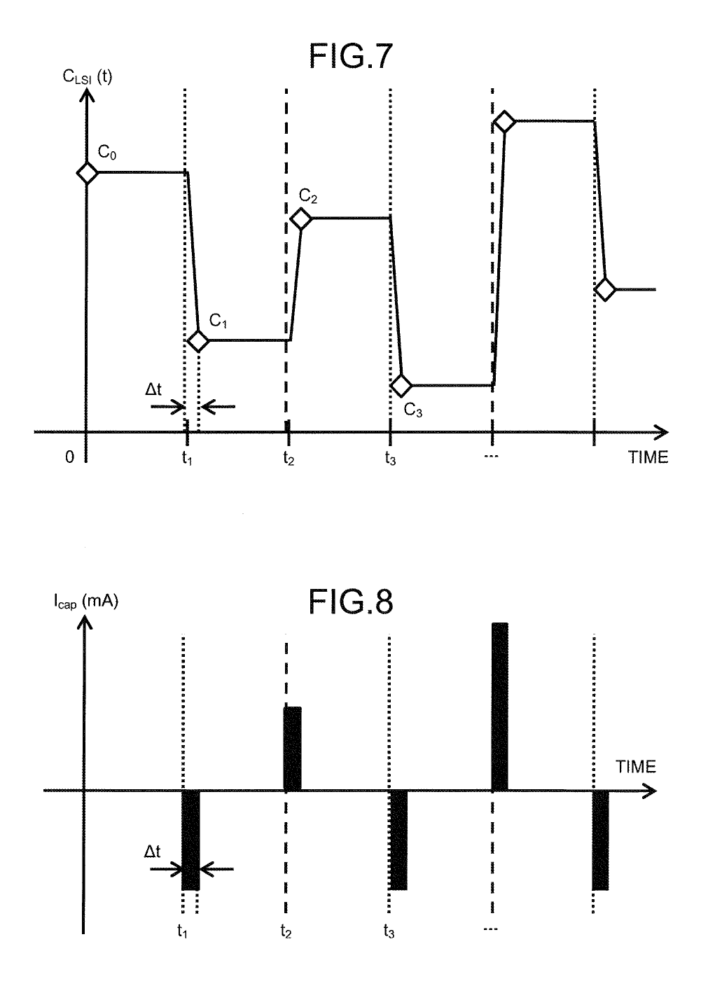

FIG. 7 is a diagram of an example of temporal variation of the inter-power-source capacitance of the integrated circuit. It is assumed as depicted in FIG. 7 that, for example, the inter-power-source capacitance C_{LSI} of the integrated circuit varies from “C₀” to “C₁” during a time period from a time t₁ to a time [t₁+Δt]; varies from “C₁” to “C₂” during a time period from a time t₂ to a time [t₂+Δt]; and varies from “C₂” to “C₃” during a time period from a time t₃ to a time [t₃+Δt]. In this manner, a time period Δt is necessary for the transition of the state at each time point; charging or discharging of C_{LSI} is executed during this Δt; and current flows.

FIG. 8 is a diagram of an example of a current-temporal waveform for the temporal variation of the inter-power-source capacitance depicted in FIG. 7. As depicted in FIG. 8, a current I_{cap} flows during the time period of Δt at each time point. When C_{LSI} increases, I_{cap} flows such that the capacitive element 23 is charged and, when C_{LSI} decreases, I_{cap} flows such that the capacitive element 23 is discharged.

The temporal variation of charge Q(t) accumulated in the capacitive element 23 of the model depicted in FIG. 6 is expressed by Eq. (4) denoting the voltage between the power supply wires V_{DD} and V_{SS} as “V_{D}S”.

Q(t)=C_{LSI}(t)V_{DS} (4)

The current I_{cap}(t) caused by the temporal variation of the inter-power-source capacitance C_{LSI} is acquired by temporally differentiating the charge Q(t). Therefore, I_{cap}(t) is expressed by Eq. (5).

$$\frac{d Q ( t )}{d t} = {V}_{DS} \frac{d {C}_{LSI} ( t )}{d t} ≡ {I}_{cap} ( t ) \qquad ( 5 )$$

The time period Δt necessary for the transition of the state can be approximated by, for example, a time period tₚₐₜₕ necessary as a time period from the time when a clock is input into a flip-flop until the time when a signal is propagated to the next flop-flop. “tₚₐₜₕ” is acquired by, for example, executing static timing analysis. Therefore, Δt can easily be acquired by approximating Δt using tₚₐₜₕ.

For example, denoting the minimal value of tₚₐₜₕ as “tₘᵢₙ”, as expressed in Eq. (6), the time period Δt necessary for the transition of the state may be set to be tₘᵢₙ. In this case, the time period Δt necessary for the transition of the state is shortened. Therefore, the current I_{cap}(t) caused by the temporal variation of the inter-power-source capacitance C_{LSI} can be estimated to be large.

Δt=tₘᵢₙ (6)

For example, denoting the maximal value of tₚₐₜₕ as “tₘₐₓ”, as expressed in Eq. (7), the time period Δt necessary for the transition of the state may be set to be a median value of tₘₐₓ and tₘᵢₙ.

$$Δ t = \frac{{t}_{max} + {t}_{min}}{2} \qquad ( 7 )$$

For example, denoting the probability density function of tₚₐₜₕ as “p(t)”, as expressed in Eq. (8), the time period Δt necessary for the transition of the state may be set to be an average value.

Δt=∫ₜ_{ₘᵢₙ}^{t}^{ₘₐₓ}t·p(t)dt (8)

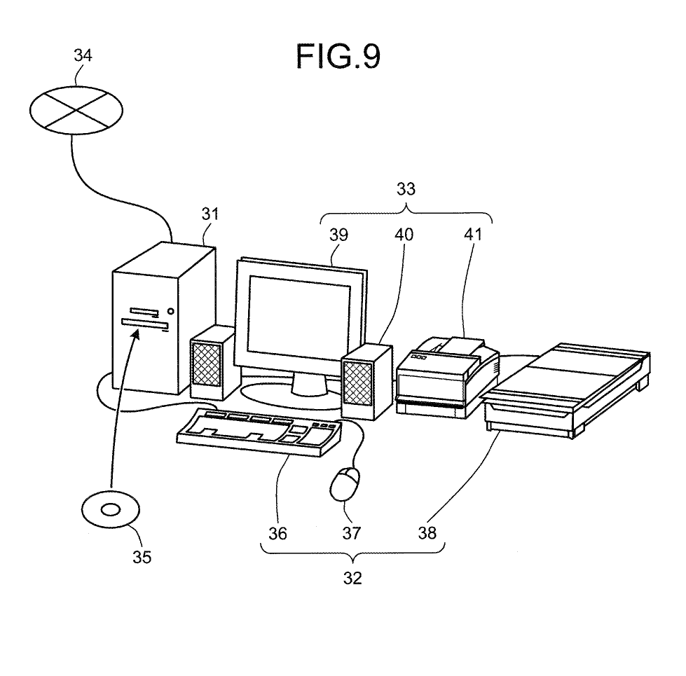

FIG. 9 is a block diagram of a hardware configuration of the circuit design support apparatus according to the embodiment. As depicted in FIG. 9, the circuit design support apparatus may have a computer 31, input devices 32, and output devices 33. The circuit design support apparatus can be connected to a network 34 such as a local area network (LAN), a wide area network (WAN), and the internet, via a non-depicted router or modem.

The computer 31 may have a central processing unit (CPU), a storage device, and an interface. The CPU governs overall control of the circuit design support apparatus. The storage device may be implemented by any one or more among read-only memory (ROM), random access memory (RAM), a hard disk (HD), an optical disk 35, and flash memory.

The storage device is used as a work area of the CPU. The storage device stores various programs that are loaded in response to commands from the CPU. The reading and writing of data with respect to the HD and the optical disk 35 is controlled by a hard disk drive. The optical disk 35 and flash memory are detachable from the computer 31.

The interface controls input from the input devices 32, output to the output devices 33, and transmission and reception with respect to the network 34. A keyboard 36, a mouse 37, and a scanner 38, etc. are example of the input devices 32. The keyboard includes, for example, keys for inputting letters, numerals, and various instructions and performs the input of data. The keyboard 36 may be a touch panel. The mouse 37 is used to move the cursor, select a region, or move and change the size of windows.

The scanner 38 optically reads images. The read images are taken in as image data and stored to a storage device in the computer 31. The scanner 38 may have an optical character reader (OCR) function.

The output apparatus 33 can be, for example, a display 39, a speaker 40, or a printer 41. The display 39 displays data such as a document, an image, and functional information in addition to a cursor, an icon, and a tool box. The speaker 40 outputs sounds such as a sound effect and a reading voice. The printer 41 prints image data and document data.

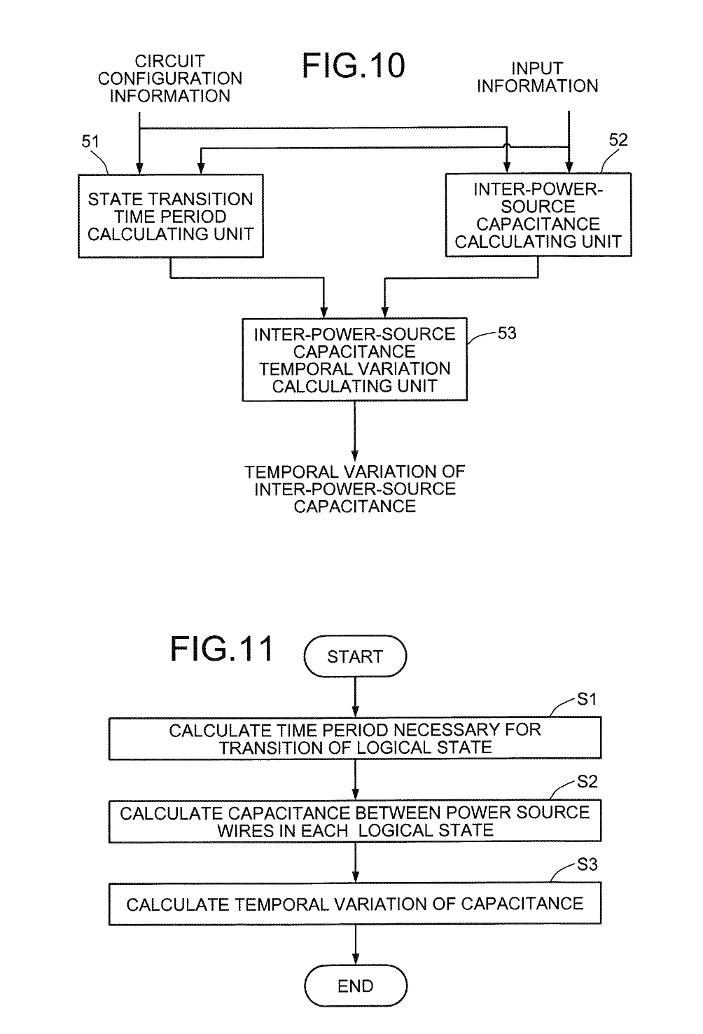

FIG. 10 is a diagram of an example of the functional configuration of a circuit design support apparatus according to the embodiment. As depicted in FIG. 10, the circuit design support apparatus may include a state transition time period calculating unit 51, an inter-power-source capacitance calculating unit 52, and an inter-power-source capacitance temporal variation calculating unit 53.

The state transition time period calculating unit 51 calculates the time period necessary for the transition of the logical state based on circuit configuration information and input information. The circuit configuration information is information indicating the connection relations of the elements of an integrated circuit and is, for example, a netlist in an SPICE format or a Verilog netlist. The input information is information indicating the logical values to be input into the input terminals of the integrated circuit, and is input vector information such as a value change dump (VCD) that has information concerning the variation of the waveform described therein. As described above concerning the time period Δt necessary for state transition, the state transition time period calculating unit 51 may acquire the time period Δt necessary for the transition of the logical state by calculating, for example, Eq. (6), Eq. (7), or Eq. (8).

The inter-power-source capacitance calculating unit 52 calculates the capacitance between the power source wires in each of the logical states based on the circuit configuration information and the input information. The inter-power-source capacitance calculating unit 52 may use, for example, the linear circuit model of an integrated circuit power source as depicted in FIG. 6. The inter-power-source capacitance calculating unit 52 may acquire the capacitance C_{LSI} between the power source wires in each of the logical states by calculating, for example, Eq. (3) for each state of the logical values input into the input terminals of the integrated circuit for the linear circuit model of the integrated circuit power source. For example, the inter-power-source capacitance calculating unit 52 may acquire the capacitance C_{LSI} between the power source wires in each of the logical states using a method disclosed by Hagiwara, Shiho, et al in “Linear Time Calculation of State-Dependent Power Distribution Network Capacitance” (International Symposium on Quality Electronic Design (ISQED), pp. 75-80, San Jose, March 2010.)

The inter-power-source capacitance temporal variation calculating unit 53 receives from the inter-power-source capacitance calculating unit 52, information concerning the capacitance C_{LSI} between the power source wires in each of the logical states and also receives from the state transition time period calculating unit 51, information concerning the time period Δt necessary for the transition of the logical state. The inter-power-source capacitance temporal variation calculating unit 53 may calculate the variation of the capacitance C_{LSI} between the power source wires during the time period Δt necessary for the transition of the logical state and thereby, may acquire the inter-power-source capacitance temporal variation C_{LSI}(t). The temporal variation C_{LSI}(t) of the inter-power-source capacitance as depicted in, for example, FIG. 7 is acquired by the inter-power-source capacitance temporal variation calculating unit 53.

The state transition time period calculating unit 51, the inter-power-source capacitance calculating unit 52, and the inter-power-source capacitance temporal variation calculating unit 53 may be implemented by, for example, executing the CPU, programs concerning the functions of the units 51 to 53 stored in a storage device of the circuit design support apparatus depicted in FIG. 9, or by using the interface for input and output. The computer 31 may acquire from the network 34, the programs concerning the functions of the units 51 to 53 and may execute the programs on the CPU.

The circuit configuration information and the input information may be retained in, for example, a storage device of the circuit design support apparatus depicted in FIG. 9. Data output from the state transition time period calculating unit 51, the inter-power-source capacitance calculating unit 52, and the inter-power-source capacitance temporal variation calculating unit 53 may be retained in, for example, a storage device of the circuit design support apparatus depicted in FIG. 9.

FIG. 11 is a diagram of an example of a circuit design support method according to the embodiment. The circuit design support method depicted in FIG. 11 may be executed by the circuit design support apparatus depicted in FIG. 10. In the embodiment, a case will be described where the circuit design support apparatus depicted in FIG. 10 executes the circuit design support method depicted in FIG. 11.

As depicted in FIG. 11, when a program that implements the circuit design support method is started, the circuit design support apparatus, via the state transition time period calculating unit 51, calculates the time period Δt necessary for the transition of the logical state, based on the circuit configuration information and the input information (step S1). The circuit design support apparatus calculates, via the inter-power-source capacitance calculating unit 52, the capacitance C_{LSI} between the power source wires in each of the logical states, based on the circuit configuration information and the input information (step S2). Either one of steps S1 and S2 may be executed before to the other, or steps S1 and S2 may be executed concurrently.

The circuit design support apparatus calculates, via the inter-power-source capacitance temporal variation calculating unit 53, the temporal variation C_{LSI}(t) of the capacitance between the power source wires, based on the time period Δt necessary for the transition of the logical state and the capacitance C_{LSI} between the power source wires (step S3). The circuit design support apparatus causes the series of process steps to come to an end.

According to the circuit design support apparatus depicted in FIG. 10, the temporal variation C_{LSI}(t) of the capacitance between the power source wires can be acquired. From the temporal variation C_{LSI}(t) of the capacitance between the power source wires, the current that flows from the power source during the operation of the integrated circuit is derived. Therefore, the current flowing from the power source during the operation of the integrated circuit can be estimated with high accuracy.

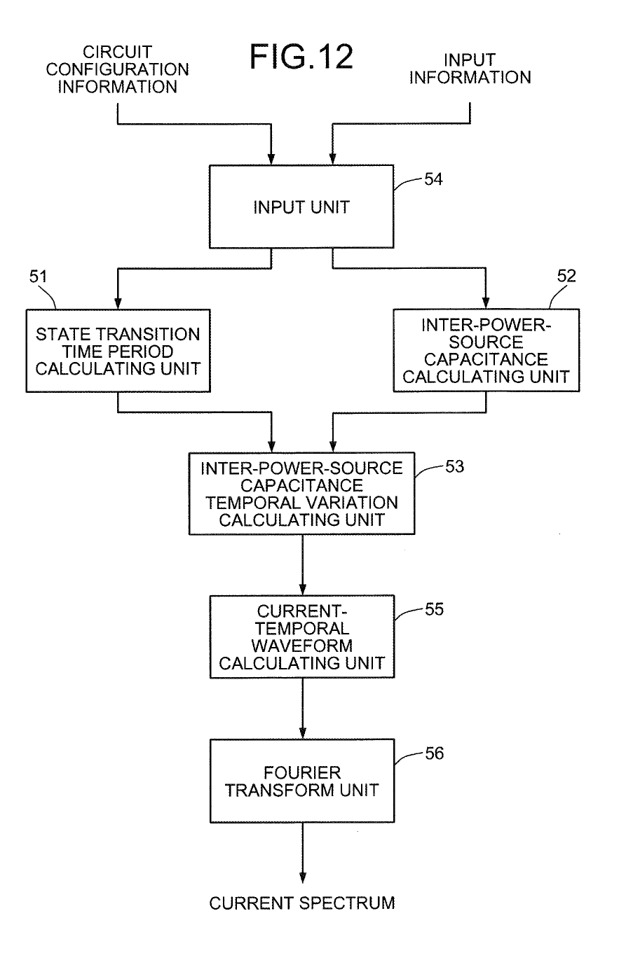

FIG. 12 is a diagram of another example of the functional configuration of the circuit design support apparatus according to the embodiment. As depicted in FIG. 12, the circuit design support apparatus may include an input unit 54, the state transition time period calculating unit 51, the inter-power-source capacitance calculating unit 52, the inter-power-source capacitance temporal variation calculating unit 53, a current-temporal waveform calculating unit 55, and a Fourier transform unit 56.

The input unit 54 inputs into the circuit design support apparatus, the circuit configuration information such as the netlist and the input information such as the VCD. The state transition time period calculating unit 51, the inter-power-source capacitance calculating unit 52, and the inter-power-source capacitance temporal variation calculating unit 53 are described above and will not be further described.

The current-temporal waveform calculating unit 55 receives from the inter-power-source capacitance temporal variation calculating unit 53, information concerning the temporal variation C_{LSI}(t) of the capacitance between the power sources; and acquires the current-temporal waveform I_{cap}(t) by calculation based on the temporal variation C_{LSI}(t) of the capacitance between the power sources. For example, as described above, the current-temporal waveform calculating unit 55 may acquire the current-temporal waveform I_{cap}(t) by calculating, for example, Eq. (5). The temporal variation I_{cap}(t) of the current waveform as depicted in, for example, FIG. 8 is acquired by the current-temporal waveform calculating unit 55.

The Fourier transform unit 56 receives from the current-temporal waveform calculating unit 55, information concerning the current-temporal waveform I_{cap}(t) and may acquire the current waveform in the frequency region, that is, the current spectrum I_{cap}(ω) by executing Fourier transform for the current-temporal waveform I_{cap}(t).

The state transition time period calculating unit 51, the inter-power-source capacitance calculating unit 52, the inter-power-source capacitance temporal variation calculating unit 53, the current-temporal waveform calculating unit 55, and a Fourier transform unit 56 may be implemented by, for example, executing on the CPU, programs concerning the functions of the units 51 to 53, 55, and 56 and stored in the storage device of the circuit design support apparatus depicted in FIG. 9, or by using the interface for input and output. The computer 31 may acquire from the network 34, the programs concerning the functions of the units 51 to 53, 55, and 56 and may execute the programs on the CPU.

For example, the input unit 54 may cause the circuit configuration information and the input information from the input apparatus 32 and the optical disk 35 to be retained in a storage device consequent to operation of the input apparatus 32. The input unit 54 may acquire the circuit configuration information and the input information from the network 34 and may cause the storage device to retain the information.

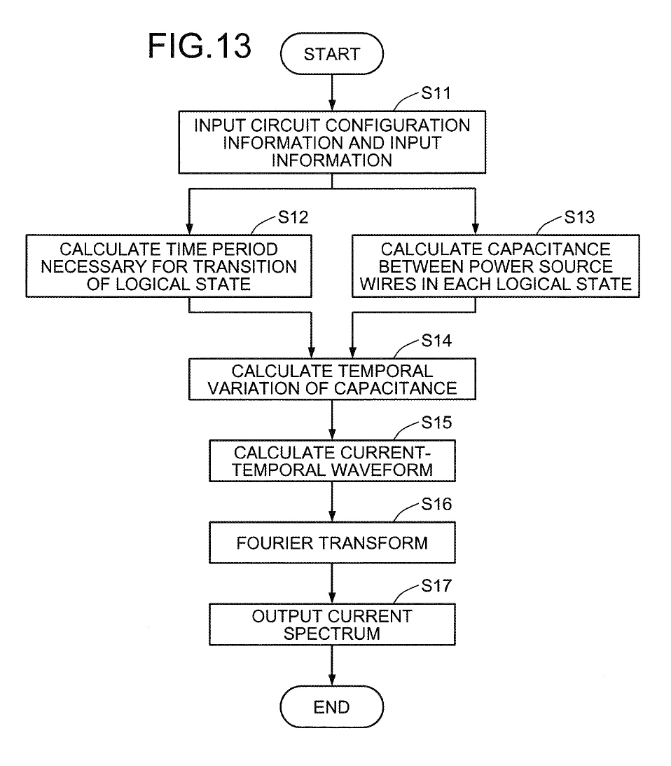

FIG. 13 is a diagram of another example of the circuit design support method according to the embodiment. The circuit design support method depicted in FIG. 13 may be executed by the circuit design support apparatus depicted in FIG. 12. In the embodiment, a case will be described where the circuit design support apparatus depicted in FIG. 12 executes the circuit design support method depicted in FIG. 13.

As depicted in FIG. 13, when a program that implements the circuit design support method is started, the input unit 54 inputs the circuit configuration information and the input information into the circuit design support apparatus (step S11). The circuit design support apparatus calculates, via the state transition time period calculating unit 51, the time period Δt necessary for the transition of the logical state, based on the circuit configuration information and the input information (step S12).

The circuit design support apparatus calculates, via the inter-power-source capacitance calculating unit 52, the capacitance C_{LSI} between the power source wires in each of the logical states, based on the circuit configuration information and the input information (step S13). Either one of steps S12 and S13 may be executed before to the other, or steps S12 and S13 may be executed concurrently.

The circuit design support apparatus calculates, via the inter-power-source capacitance temporal variation calculating unit 53, the temporal variation C_{LSI}(t) of the capacitance between the power source wires, based on the time period Δt necessary for the transition of the logical state and the capacitance C_{LSI} between the power source wires (step S14) and calculates, via the current-temporal waveform calculating unit 55, the current-temporal waveform I_{cap}(t) based on the temporal variation C_{LSI}(t) of the capacitance between the power source wires (step S15).

The circuit design support apparatus acquires the current spectrum I_{cap}(ω) by executing, via the Fourier transform unit 56, Fourier transform for the current-temporal waveform I_{cap}(t) (step S16), outputs the current spectrum I_{cap}(ω) (step S17), and causes the series of process steps to come to an end.

According to the circuit design support apparatus depicted in FIG. 12, the current spectrum I_{cap}(ω) is acquired from the temporal variation C_{LSI}(t) of the capacitance between the power source wires. The current spectrum I_{cap}(ω) is the current that flows from the power source during the operation of the integrated circuit. Therefore, the current that flows from the power source during the operation of the integrated circuit can be estimated with high accuracy.

Example of Accuracy Improvement Effect of Odd-Numbered Harmonic Components

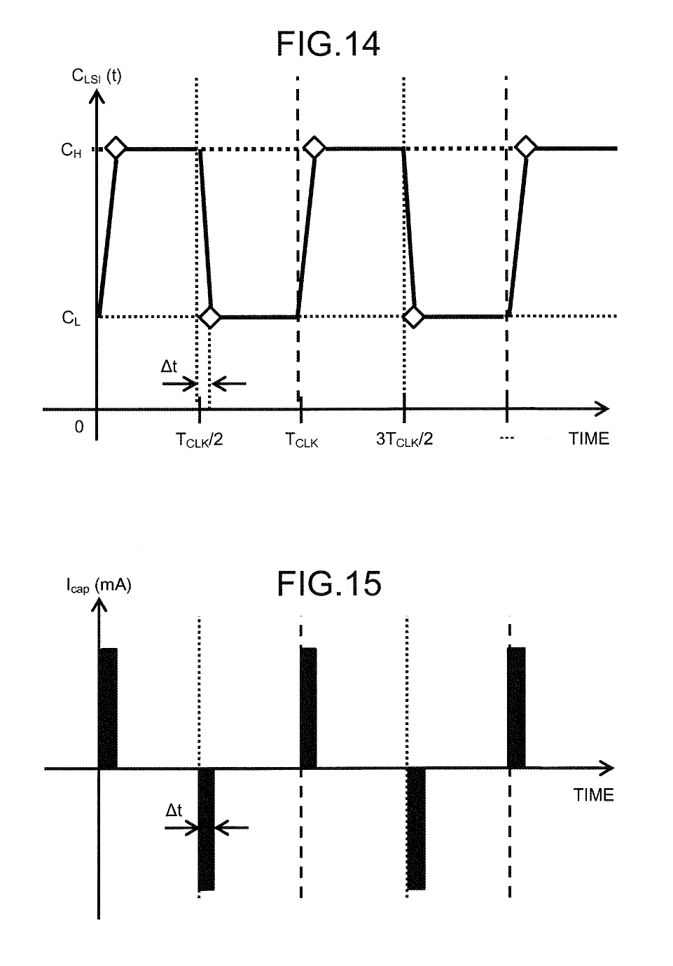

FIG. 14 is a diagram of another example of the temporal variation of the capacitance between the power sources of the integrated circuit. FIG. 15 is a diagram of another example of the current-temporal waveform for the temporal variation of the capacitance between the power sources depicted in FIG. 14.

The inter-power-source capacitance C_{LSI} of the integrated circuit significantly varies when the “high” and “low” of the clock are switched therebetween. To simplify the description, as depicted in FIG. 14, the inter-power-source capacitance C_{LSI} of the integrated circuit is denoted, for example, by “C_{H}” when the clock is “high” and by “C_{L}” when the clock is “low”, and the clock cycle is denoted by “T_{CLK}”.

As depicted in FIG. 14, assuming that the inter-power-source capacitance C_{LSI} of the integrated circuit is switched between C_{H} and C_{L} every [T_{CLK}/2], a current-temporal waveform as depicted in FIG. 15 is acquired. Therefore, the current-temporal waveform I_{cap}(t) is expressed by Eq. (9).

$${I}_{cap} ( t ) = \{ \begin{matrix}{I}_{0} , & 0 \leq t < Δ t \\ - {I}_{0} , & {T}_{CLK} / 2 \leq t < {T}_{CLK} / 2 + Δ t \\ 0 , & ELSE\end{matrix} \qquad ( 9 )$$

Eq. (10) is acquired by executing Fourier transform for I_{cap}(t) that is expressed by Eq. (9). In Eq. (10), “I_{cap}(n/T_{cLK})” is the current value at a frequency that is n times as high as the clock frequency. “m” is an integer that is zero or greater. When the time period Δt necessary for the transition of the state is shorter than the clock cycle T, the current value at a frequency that is an odd-number times as high as the clock frequency is expressed by Eq. (11).

$$\begin{matrix}{I}_{cap} ( n / {T}_{CLK} ) = \{ \begin{matrix}0 , & n = 2 m \\ 2 {I}_{0} {\int }_{0}^{Δ t} {e}^{- j \frac{2 π n}{T} t } d t , & n = 2 m + 1\end{matrix} & ( 10 ) \\ WHEN \\ Δ t ≪ {T}_{CLK} , {I}_{Cap} ( n / {T}_{CLK} ) = 2 {I}_{0} Δ t & ( 11 )\end{matrix}$$

From Eqs. (10) and (11), it can be seen that the current value is zero at a frequency that is an even-number times higher than the clock frequency and the current value is 2I₀Δt at a frequency that is an odd-number times higher than the clock frequency. The current spectrum I_{cap}(ω) of the current flowing from the power source during the operation of the integrated circuit includes only the components at the frequency that is an odd-number times higher than the clock frequency. Therefore, even at a frequency that is an odd-numbered times higher than the clock frequency, the current flowing from the power source during the operation of the integrated circuit can be estimated with high accuracy.

Example of Improvement Effect of Analysis Time Period of Current Flowing from Power Source

The current that flows from the power source when the inter-power-source capacitance C_{LSI} of the integrated circuit varies, can be acquired by executing transient analysis for the netlist of the transistor levels using SPICE. However, the analysis time period of SPICE increases by an order of about [w^{1.3}] in proportion to the scale of the circuit and therefore, the analysis takes an excessively long time.

One example based on ITRS 2011 Edition (2011 Overall Roadmap Technology Characteristics (ORTC) Tables (Table ORTC-2C), http://www.itrs.net/Links/2011ITRS/Home2011.htm) is given. According to ITRS 2011 Edition, the number of transistors per chip is set to be about 3×10⁹, the number of transistors per gate is set to be four, whereby the number of gates per chip is about 8×10⁸.

Using the circuit design support apparatus depicted in FIG. 12, the time period for calculating the inter-power-source capacitance C_{LSI} of the integrated circuit and the time period necessary for static timing analysis are linearly related to the number of gates. Therefore, for an integrated circuit whose number of gates “w” is, for example, about 8×10⁸, dividing the calculation time period [w^{1.3}] based on SPICE by the calculation time period w consumed when the circuit design support apparatus depicted in FIG. 12 is used, yields about 468.

In other words, using the circuit design support apparatus depicted in FIG. 12 enables the analysis to be executed in a time period that is about one 468th of the time period take when SPICE is used. The number of gates per chip tends to increase. Therefore, it is expected that, from now on, the difference will become larger in the time period for executing the analysis between the case where the circuit design support apparatus depicted in FIG. 12 is used and the case where SPICE is used.

As described, the current spectrum I_{cap}(ω) of the current flowing from the power source when the logical state of the integrated circuit transitions can be acquired. The current spectrum I_{cell}(ω) of the current caused to flow from the power source by a logical cell can be acquired. The method of acquiring I_{cell}(ω) is disclosed in, for example, the above '960 or '338 Publications.

Addition of I_{cell}(ω) and I_{cap}(ω) enables acquisition of the current spectrum I_{ckt}(ω) of the integrated circuit. When the current flowing from the power source can be acquired with high accuracy as described, unnecessary radiation can be estimated with high accuracy. Therefore, sufficient measures can be taken against the unnecessary radiation.

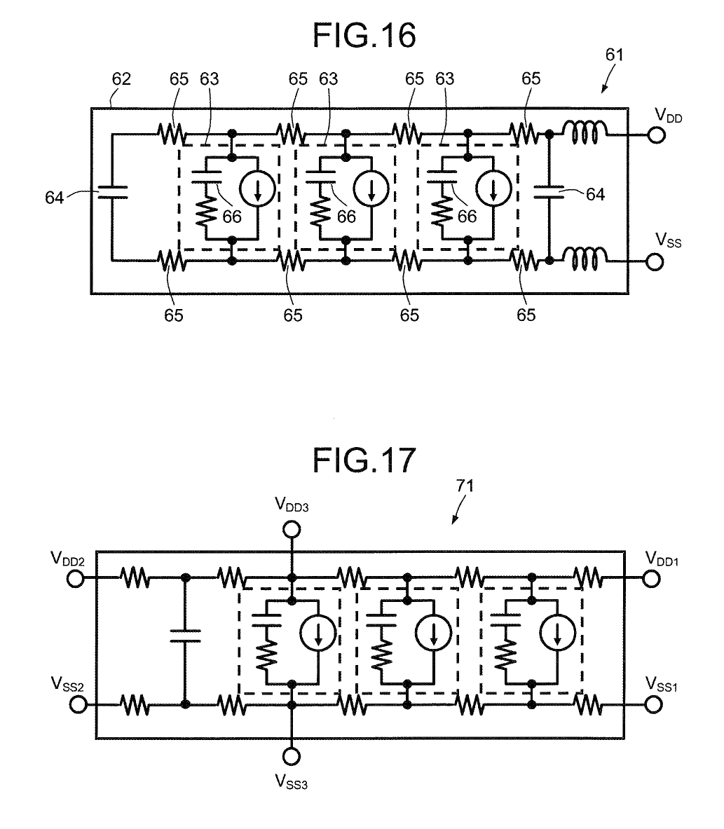

FIG. 16 is a diagram (Part I) of another example of a linear circuit model of the integrated circuit power source. In the linear circuit model 61 of the integrated circuit power source depicted in FIG. 16, a power source model 62 for the entire chip includes plural power source models 63 of the circuit blocks similar to the linear circuit models 21 of the integrated circuit power source depicted in FIG. 6. The power source model 63 in each circuit block includes one or more logic gates and is connected by an RLC network, an RC network, or an R network of the power source network of the power source model 62 for the whole chip.

A capacitive element 66 included in the power source model 63 of each circuit block is dependent on the state similarly to the capacitive element 23 of the linear circuit model 21 of the integrated circuit depicted in FIG. 6. Therefore, using the circuit design support apparatus depicted in FIG. 10 or that depicted in FIG. 12 enables highly accurate estimation of the current flowing from the power source during the operation of the integrated circuit. In FIG. 16, a reference numeral “64” denotes parasitic capacitance of a power source network and a reference numeral “65” denotes parasitic resistance of the power source network.

FIG. 17 is a diagram (Part II) of another example of the linear circuit model of the integrated circuit power source. A linear circuit model 71 of the integrated circuit power source depicted in FIG. 17 includes plural power source terminals whose voltage levels are each different from each other, for each of the power supply wires V_{DD} and V_{SS} in the linear circuit model 61 of the integrated circuit power source depicted in FIG. 16. In FIG. 17, V_{DD1}, V_{DD2}, and V_{DD3} may have voltage levels each different from each other and V_{SS1}, V_{SS2}, and V_{SS3} may have voltage levels each different from each other.

In the linear circuit model 21 of the integrated circuit power source depicted in FIG. 6, the resistive element may be omitted. In the power source model 63 of each circuit block of the linear circuit model 61 of the integrated circuit power source depicted in FIG. 16, the resistive element may be omitted. In the linear circuit model 71 of the integrated circuit power source depicted in FIG. 17, the resistive element in the power source model 63 of each circuit block may be omitted.

The circuit design support method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

The circuit design support apparatus described in the present embodiment can be realized by an application specific integrated circuit (ASIC) such as a standard cell or a structured ASIC, or a programmable logic device (PLD) such as a field-programmable gate array (FPGA). Specifically, for example, functional units (51 to 53, 55, and 56 of the circuit design support apparatus are defined in hardware description language (HDL), which is logically synthesized and applied to the ASIC, the PLD, etc., thereby enabling manufacture of the circuit design support apparatus.

The current flowing from a power source during the operation of an integrated circuit can be estimated with high accuracy at the design stage of an integrated circuit.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A circuit design support apparatus comprising:
a processor configured to:
calculate a time period necessary for a transition of a logical state, based on circuit configuration information indicating connection relations of elements of an integrated circuit and input information indicating a logical value input into an input terminal of the integrated circuit;
calculate capacitance between power source wires in each logical state based on the circuit configuration information and the input information; and
calculate temporal variation of the capacitance based on the capacitance and the time period.

2. The circuit design support apparatus according to claim 1, wherein
the processor calculates the time period based on a time period necessary for propagation of a signal between flip-flops.

3. The circuit design support apparatus according to claim 1, the processor further configured to
calculate a current-temporal waveform based on the temporal variation of the capacitance.

4. The circuit design support apparatus according to claim 3, the processor further configured to
acquire a current spectrum by executing Fourier transform for the current-temporal waveform.

5. A circuit design support method executed by a processor, the circuit design support method comprising:
calculating a time period necessary for a transition of a logical state, based on circuit configuration information indicating connection relations of elements of an integrated circuit and input information indicating a logical value input into an input terminal of the integrated circuit;
calculating capacitance between power source wires in each logical state based on the circuit configuration information and the input information; and
calculating temporal variation of the capacitance based on the capacitance and the time period.

6. The circuit design support method according to claim 5, wherein
the calculating of the time period includes calculating the time period based on a time period necessary for propagation of a signal between flip-flops.

7. The circuit design support method according to claim 5, further comprising
calculating a current-temporal waveform based on the temporal variation of the capacitance.

8. The circuit design support method according to claim 7, further comprising
acquiring a current spectrum by executing Fourier transform for the current-temporal waveform.

9. A computer-readable recording medium storing a circuit design support program causing a computer to execute a process comprising:
calculating a time period necessary for a transition of a logical state, based on circuit configuration information indicating connection relations of elements of an integrated circuit and input information indicating a logical value input into an input terminal of the integrated circuit;
calculating capacitance between power source wires in each logical state based on the circuit configuration information and the input information; and
calculating temporal variation of the capacitance based on the capacitance and the time period.
